(19) United States
(12) Patent Application Publication
(10) Pub. No.: US 2010/0294254 A1
(43) Pub. Date: Nov. 25, 2010

(54) Inverted cross-scavenged, two-overhead valve, 2-stroke engine

(76) Inventor: Michael A.V. Ward, Lexington, MA (US)

Correspondence Address: MICHAEL A.V. WARD, 20 MARRETT ROAD, LEXINGTON, MA, 02421, US

(21) Appl. No.: 12/657,176

(22) Filed: Jan. 16, 2010

Related U.S. Application Data
(60) Provisional application No. 61/216,867, filed on May 22, 2009.
(60) Provisional application No. 61/275,844, filed on Sep. 3, 2009.

(51) Int. Cl. F02B 25/00; F02P 15/02; H01T 13/08; F02B 33/00; F02M 51/00; F02B 23/00

(52) U.S. Cl. 123/65 R; 123/310; 123/169 R; 123/565; 123/478; 123/661

(57) ABSTRACT

A two-stroke internal combustion engine which has an Inverted Cross-Scavenged operation forming a 180° air and exhaust gas loop and having two overhead valves [46, 47] in the cylinder head and optimized coils [43, 44] per spark plug [41, 42], the spark plugs being halo-disc type plugs, a central fuel-injector means [45], and the combustion chamber forming a Perfect Miller Cycle with an effective CR of approximately 10.5 to 1 and ER equal to approximately 18 to 1, and the valves opening at near bottom center (BC) and closing at approximately 75° after BC, and a quick response super-charger or turbo-charger located at the intake.

This application claims priority under USC 119(e) of U.S. provisional application Ser. No. 61/216,867, filed May 22, 2009, and Ser. No. 61/275,844, filed Sep. 3, 2009.

### FIELD OF THE INVENTION

This invention relates to a two stroke internal combustion (IC) engine wherein the 2-stroke engine has an ultra-lean burn capability, a high efficiency, and high power operation with high squish flow in the region of ignition and combustion, and is low-cost.

### BACKGROUND OF THE INVENTION AND PRIOR ART

The invention pertains to a 2-stroke internal combustion engine preferably using dual, high energy, flow-coupling ignition systems with high energy density coils, operating at higher voltage and current, with squish-flow which produce high flow at the spark plug site(s) during ignition. It is unusual to have a 2-stroke engine with two valves in the cylinder head, an intake and an exhaust valve, and the scavenging resembling an up-side down or mirror image of a cross-scavenged 2-stroke engine, i.e. viewed as an inverted-cross-scavenged [180° rotated]. This engine, the 2-Stroke Inverted Cross-Scavenged (ICS) engine, has a combustion chamber resembling the May Fireball i.e. the combustion chamber mainly under the exhaust valve [Automotive Engineering Vol. 84, No. 6], and having practically no volume below the intake valve (having it be a squish region at top center, TC), referred to as the May combustion chamber. Unlike the May chamber it has two plugs instead of one, and has one direct fuel injector, among many other differences. Since the engine is a 2-stroke, its breathing [intake and exhaust] is different from that of a 4-stroke, by necessity, i.e. the two valves [intake and exhaust] open at about 15° before and close at 80° after bottom center (BC). The effective compression ratio (CR) is approximately 10.5 to 1, and the expansion ratio (ER) is approximately 18 to 1.

The invention preferably has a 42 volt based coil-per-plug inductive ignition system as disclosed in my U.S. Pat. No. 6,142,130, referred to henceforth as '130, having a high energy coils of about 150 mj and high spark currents in the 200 to 600 ma range; and have a pair of biasing magnets in the open end of the E-core, as has been disclosed, in part, in my U.S. Pat. No. 7,178,513, referred to henceforth as '513, and in my U.S. Pat. No. 7,182,077, referred to henceforth as '077. The invention relates mainly to two-stroke engines with direct fuel injection means, with two plugs per cylinder with high energy density coils (optimized coils), preferably directly mounted on the plugs and on the cylinder head, preferably using improved halo-disc plug shown in patent '513 and in my patent application Ser. No. 12/319,982 and Ser. No. 12/434,148, referred to henceforth as '982 and '148. The Ford PROCO engine (SAE paper 780699) also uses two plugs and a central fuel injector, although it is a 4-stroke engine. The patents and patent applications are incorporated herein as though set out at length herein.

### SUMMARY AND OBJECTS OF THE INVENTION

A principle object of the present invention is to have a two-stroke Inverted Cross-Scavenged (2-Stroke ICS) engine using two-valves in the head, an intake and exhaust, and two-plugs [preferably halo-disc plugs] and at least one in-cylinder fuel injector, and wherein the effective compression ratio (CR) is approximately 10 to 1, and the expansion ratio (ER) is a high ER approximately 18 to 1, and wherein the intake requires no throttle. Instead, the intake air may need to be slightly pressurized by a quick response electrical operated Supercharger, and wherein the two valves [intake and exhaust] open at approximately 15° to approximately 45° before bottom center (BBC) and close approximately 80° after bottom center (ABC) and wherein the intake air moves downwards at the outer edge of the intake valve and exhaust moves upwards at the outer edge of the exhaust valve, defining a 180° scavenging loop, like an inverted or mirrored cross-scavenged flow, and the fuel is injected immediately after or just the valves close, and the mixture at the time of ignition may be stratified or homogeneous.

The term “approximately” or “approximately equal to” as used throughout this specification means within plus or minus 25% of the value it qualifies. The term “equal to” means plus or minus 10% of the value it qualifies, unless otherwise stated; and the term “about” means between 0.5 and 2 times the term it qualifies.

It is an aspect of the invention to have two high energy ignition plugs per cylinder placed opposite to each other, with a fuel injector placed approximately in the middle of the head, also placed approximately between the intake and exhaust valves.

Another aspect of the invention is to have the exhaust valve open approximately 150° after top center [ATC] and close approximately 80° after bottom center [ABC]. The valves open and close at approximately the same time and the pressure in the fresh intake air is P0+ΔP and in the exhaust is P0−ΔP, and the intake helps push the burnt gases (scavenged) through the exhaust valve in a direction of a semi-circular loop, wherein the intake air is at atmospheric or at slightly higher pressure, and the exhaust at BC is preferably just below atmospheric pressure (P0) due to the high ER. It may be that the pressure of the intake air is not sufficiently above the pressure of the exhaust gases at BC in which case a quick-response electric Supercharger is employed at the intake, while the exhaust valve would open at, say, slightly before BC to allow for blow-down to take place, so that exhaust gases may escape through the exhaust valve and the pressure of the exhaust may drop, and the difference in pressures between the intake and exhaust may increase [so that the intake pressure around BC is Pin0 may be greater than the exhaust pressure Pex0 at BC].

Another aspect of the invention is to have the ignition coils directly mountable on the plugs and on the cylinder head, preferably on halo-disc spark plugs, preferably as shown in my patent application '148.

Another aspect of the invention is to have a two-stroke inverted cross-scavenged [2-Stroke ICS] cylinder head with two spark plugs located at right angles to the vertical valves [located in the same horizontal plane], and a fuel injector located in the center of the head able to inject fuel via electronic control at single times around valve closure or in addition at multi-times in a firing cycle, i.e. approximately 45° BTC to TC, wherein the valves are closed for 135° to 180° after TC, and open for the next approximately 100°.

Another aspect of the invention is to have a May type combustion chamber which has a small clearance to the piston at TC under the intake valve and a large clearance [approximately 0.5 inches] to the exhaust valve which makes a large part of the “roof” of the combustion chamber where the intake valve is horizontal and has a cup-like volume much smaller than the cup-like volume under the exhaust valve which is also horizontal, the clearance of the intake valve at TC creates inwards radial squish-flow, and the two plugs are preferably vertical and at the edge of the two squish zones nearer the exhaust valve, so that the manufacture of the head is particularly simple and has four vertical holes drilled per cylinder (two for the valves and two for the plugs), and wherein the valves are in a longitudinal direction to the camshaft, so that a single overhead cam [SOHC] may be employed.

Another aspect of the invention is to have the intake valve shrouded on the inside, more central region, to help the intake air to enter the cylinder vertically downwards while the exhaust moves vertically upwards, creating an approximately 180° loop.

Another aspect of the invention is to have the cylinder head with two valves and two spark plugs placed at right angles to the valves, and a fuel injector located in the center of the head, and two squish-lands placed on the two sides of the valves to provide a channel near TC for the mixture to flow along, and the squish-lands to create ignition flow-coupling with the two plugs. The May-like chamber at TC has strong squish at the region under the intake valve.

Another aspect of the invention is to have two dominate operating air-fuel ratio (AFR) conditions be ultra-lean i.e. AFR≧24 to 1 for gasoline, and stochiometric AFR=14.7 to 1. When operating ultra-lean the fuel spray is towards the center of the combustion chamber, i.e. a stratified charge mixture, which there may be an air cushion at the chamber walls (no fuel impinging the walls) to minimize heat transfer to the cylinder walls.

Another aspect of the invention is to insure that the fuel injector has the capability to inject the wide range of fuel, from 100 to 1 AFR, to 10 to 1 AFR, to include other fuels than just gasoline, e.g. ethanol.

Another aspect of the invention is to insure that the exhaust valve is adequately cooled to allow a high CR, e.g. approximately 10.5 to 1. It can be replaced with a Coates spherical valve which is easier to cool, and able to permit a higher CR.

Another aspect of the invention is to insure that the effective CR is approximately 10.5 to 1 and the ER is approximately 18 to 1, to simulate a Miller Cycle, and the exhaust valve opens at about 30° BBC, intake opens at BC, and both valves close at approximately 80° ABC.

Another aspect of the invention is to insure that the effective CR is approximately 10.5 to 1 and the ER is approximately 18 to 1, to simulate a Miller Cycle, with both the intake and exhaust valves closing at approximately 80° ABC, so that the height of the volume under the exhaust valve is approximately 0.45″ at TC, and the piston to cylinder head clearance in the rest of the combustion chamber is about equal to 0.06″ at TC.

Another aspect of the invention is to insure that the engine power is controlled by a Speed-Density map, where Density is MAP in a conventional engine, and in our case it is proportional to the degree of Stratification, given that MAP≈1.

Another aspect of the invention is to insure that the engine has three dominant operating conditions: cold-start [fast idle, 15:1 AFR], lean burn operation, and WOT [wide open throttle] with approximately stoichiometric AFR preferably using a 3-way catalyst.

Another aspect of the invention is to insure that each cylinder has two valves, two plugs, at least one fuel injector, and two large squish zones across from each other along the two-valves at or near TC, in addition a squish-zone is created at the intake valve at or near TC.

Another aspect of the invention is to insure that a two-cylinder engine has vertical oriented valves and plugs and has two intakes, a warm intake and a cold intake for high power.

Another aspect of the invention is to insure that the two valve stems are oriented off-center to the openings so that the intake air and the exhaust gases flow on the outside edges of the valves.

Another aspect of the invention is to insure that the intake valve has an electric-supercharger to force the incoming air to obtain good scavenging, especially at high engine speeds and at high loads, particularly at WOT and stoichiometry AFR or slightly rich AFR.

Another aspect of the invention is to insure that the camshaft may be rotated by a small amount relative to the crankshaft to give variable timing, for example to have the valves timing varied from 45° BBC valve opening to 25°, and valves closing from 65° ABC to 85° ABC.

Another aspect of the invention is to insure that the fuel injector, in the case where it has to inject the maximum fuel, does not have to work against a pressure greater than 15 atmospheres, where the feed pressure is about 100 pounds of pressure.

Other features and objects of the invention will be apparent from the following drawings of preferred embodiments of the invention taken with the accompanying drawings, in which:

### BRIEF DESCRIPTION OF THE DRAWINGS

FIG. 1 is an approximately to scale, top view drawing of a single cylinder, two-stroke ICS (2-Stroke ICS) engine with two plugs symmetrical placed with small, high energy density optimized coils mounted on the plugs, and between the plugs and approximately located at the center of the head fuel-injector means, and two vertically oriented valves spaced about the center of the head. Preferably, two squish-flow lands are shown on the top and bottom halves of the cylinder, so that when the piston is near or at top center (TC), a channel is formed.

FIG. 2 is an approximately to scale, side view drawing of a single cylinder, two-stroke ICS engine with two plugs with small, high energy density optimized coils mounted on the plugs, and between the plugs and approximately located at the center of the head fuel-injector means with two vertically oriented valves spaced about the center of the head, with the intake valve creating high squish with the piston at TC, and the fuel injector giving the main fuel injection which mixes with the mostly fresh air, to form a partial homogeneous mixture at TC.

FIG. 2a is an approximately to-scale side-view of FIG. 2 past BC showing both valves open and the intake air moving vertically downwards from the intake valve and the exhaust moving vertically upwards through the exhaust valve, forming an ICS loop.

FIG. 2b is an approximately to-scale, side-view of FIG. 2 at about a minimum of 60° ABC, with both valves just closed, and the fuel injector just activated.

FIG. 3 is a circle drawing showing the various timing events of the 2-stroke ICS engine, where the circle represents 360° and represents a complete operating cycle.

FIG. 4 is a top view of a two-cylinder engine with two identical cylinders each having two valves, two plugs, a central fuel-injector, two squish lands on the two sides of the valves, and having two intakes, a warm intake and cold intake for power, and having a SOHC [single overhead cam]. The design is unusual in that it is a 2-stroke engine which does not require ports in the engine block. This is an advantage, and can use almost any engine block. The engine uses two halo-disc plugs and a state-of-the-art electronic fuel injector, as was used in the Ford PROCO. It uses a Miller Cycle with a high ER of approximately 18:1 for an effective CR of approximately 10.5:1, and a small Electric Supercharger on the Intake. Because it has such a high ER there is no need to consider the complexity and expense of variable ER/CR. Also, since it is truly a two stroke engine, it would have twice the power, all other things being equal. By incorporating Michael May's combustion chamber and other advantages in the 2-Stroke ICS design, it would have a low cost, simpler design Lean Burn engine with a high efficiency and power.

### DISCLOSURE OF PREFERRED EMBODIMENTS

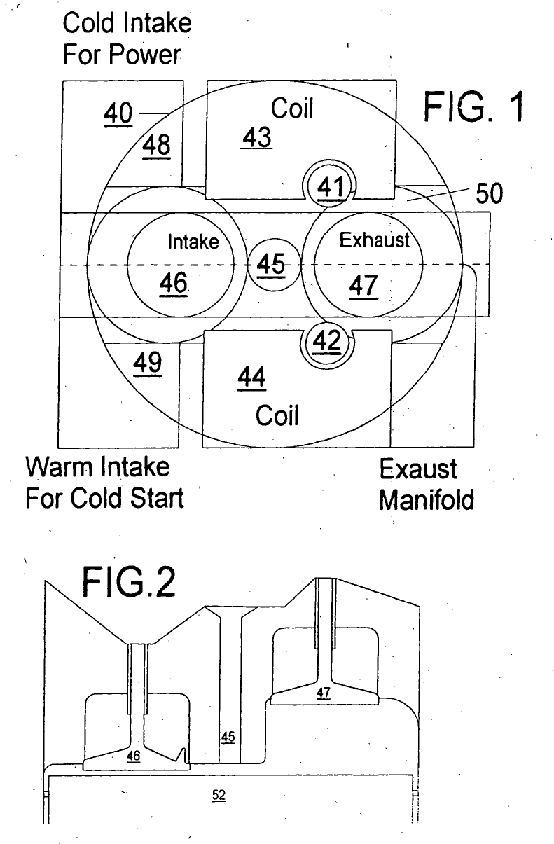

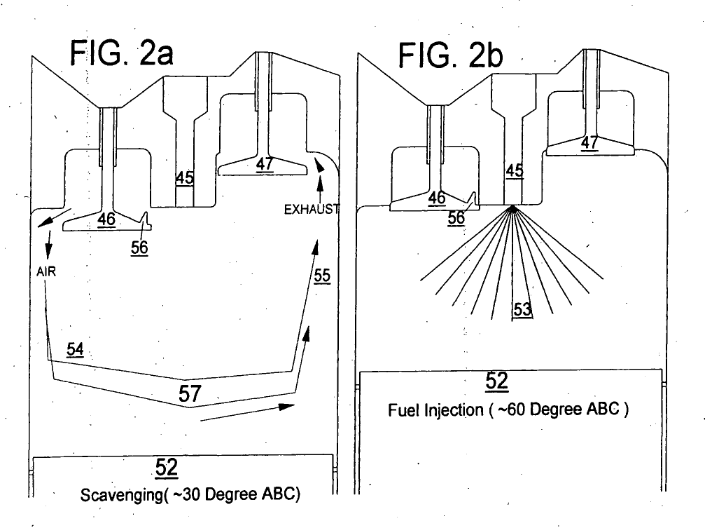

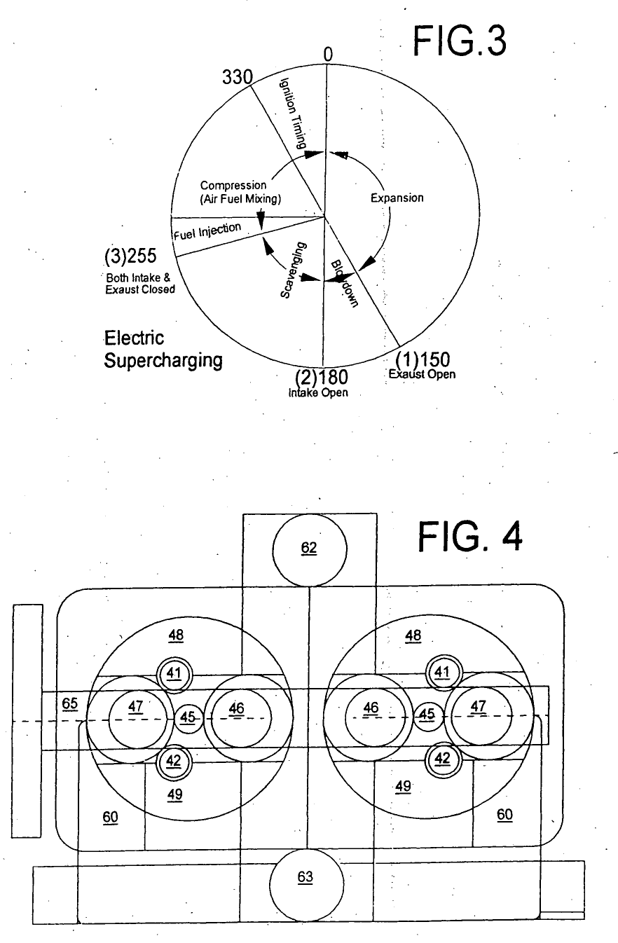

FIGS. 1 and 2 have two Optimized Coils with preferably two halo-disc spark-plugs for better ignition, in a two-stroke engine which tends to have higher residuals and need better ignition. The disclosures show a fuel injector means. In my U.S. Pat. No. 7,165,528 [referred to as '528, for short] in FIG. 3a, is shown a central fuel injector with two spark plugs and two valves. In such designs, the operation is preferably very lean for better fuel-efficiency; at AFR of 24 to 30 to 1, for gasoline, or higher AFR if stratified charge is used, and approximately stoichiometry [gasoline 14.7 AFR] for power and 3-way catalyst action. Note that the plugs are closer to the exhaust valve for a head resembling the May head (FIG. 2); but for a symmetric combustion chamber as per. FIGS. 4a and 4b of my patent application '148, the plugs would be in-line with the fuel injector [would be placed symmetrically with respect to (w.r.t.) the head].

FIG. 1 is an approximately to scale, top view drawing of a single cylinder 40, two-stroke ICS with two plugs 41 and 42 symmetrical placed with small, high energy density optimized coils 43 and 44 mounted on the plugs, and between the plugs and approximately located at the center of the head is fuel-injector means 45, and two vertically oriented valves, the intake valve 46, and the exhaust valve 47 shown off-center w.r.t. the intake and the exhaust opening, approximately equally spaced about the center of the head. Preferably, two squish-flow lands are shown on the top 48 and bottom 49 halves of the cylinder 40, so that when the piston is near or at top center (TC) a channel 50 is formed. The squish clearance between the top of squish land and the piston is about 0.06 inch at TC. The clearance [at TC] between the cylinder head in the region of the exhaust valve and the piston in the region of the channel 50 is about 0.6 inch for a compression ratio (CR) of approximately 10 to 1. Clearly, the squish flow at the two plug sites is towards the center of the combustion chamber. For a thorough discussion, see my patent application '982. Also shown are two intakes, a warm and cold intake, and the beginning of the exhaust manifold.

FIG. 2 is an approximately to scale, side view drawing of a single cylinder of representative BORE [B] of 3.5″, and STROKE [S] of 3.0″, of a two-stroke ICS engine with two plugs [not shown] with small, high energy density optimized coils mounted on the plugs [not shown], and offset but between the plugs and approximately located at the center of the head is a fuel-injector 45 [having a diameter of about ½ inch], with two vertically oriented valves 46 and 47 spaced about the center of the head. The valves are approximately 1.2 inches in diameter, with the piston 52 shown at TC and both valves closed. The combustion chamber preferably resemble the May chamber, with the intake region forming a squish region with the piston, and the combustion chamber formed mostly under the exhaust valve. Like numerals refer to like parts with respect to FIG. 1.

The fuel injector 45 can be made to operate also at the time of ignition, say about 25° BTC, to inject a small amount of fuel to help the spark ignition process, especially when an ultra lean mixture is used.

The fuel injector has a wide range of fueling capability, from an AFR of 10 to 1, to an AFR of 100 to 1.

In place of the poppet valves 46 and 47, especially the exhaust valve 47, a rotary valves can be substituted, which can be more easily controlled and cooled e.g. the COates type of rotary valve.

Note that if fresh air enters the exhaust, this is not an efficiency robbing problem as the fuel injector has not yet been fired, and no fuel is wasted by entering the exhaust.

Note that since the exhaust valve closes at approximately 120° BTC, a higher than normal compression ratio [CR] and expansion ratio [ER], which may require slightly larger squish lands, and a Miller Cycle may ensue, for example with an effective CR of approximately 10.5 to 1 and ER of approximately 18 to 1.

FIG. 2a is an approximately to-scale side-view of FIG. 2 at approximately 45° past BC showing both valves open and the intake air moving vertically downwards 54 from the intake valve and the exhaust moving vertically upwards 55 through the exhaust valve, forming an ICS loop 57. The intake valve has a shroud 56 on its inside edge to help guide the intake air vertically downwards. Like numerals refer to like parts with respect to FIGS. 1 and 2.

FIG. 2b is an approximately to-scale, side-view of FIG. 2 at about 75° ABC (a minimum of 60° ABC), with both valves just closed, and the fuel injector just activated to form a fuel spray 53. The fuel injector spray 53 giving the main fuel injection of the required fuel which mixes with the mostly fresh air, to form a partial homogeneous mixture at TC. Like numerals refer to like parts with respect to FIGS. 1 and 2.

Following FIGS. 2a and 2b, a preferred embodiment of the parameters of the 2-Stroke ICS engine, using a Miller Cycle with a high ER, e.g. ER=18 to 1, and an effective CR approximately 10.5 to 1, and the valves closing at about 80° ABC, as given below:

The exhaust valve timing

Opening time: 150° after top center (ATC)

Closing time: 100° before top center (BTC). Opening time ΔΘ=130°

The intake valve timing

Opening time: 180° ATC, or bottom center (BC)

Closing time: 100° before top center (BTC). Duration ΔΘ=100°

Compression Ratio=Expansion Ratio=CR0=ER0=18 to 1

Effective CR≈10 to 1

Effective ER=(150°/180°)·18=15 to 1

Fuel Injection Timing

Start of injection: 100° BTC

Typical end of injection: 80° BTC. Duration=20°

The major timing events

1. Expansion [0° to 150° ATC]; Duration=150°

2. Blowdown [150° ATC to BC]; Duration=30°

3. Scavenging [BC to 80° ABC]; Duration=80°

4. Compression [100° BTC to TC]; Duration=100°.

Total duration=360°

The minor timing events

1. Fuel injection [100° to 80° BTC typically]

2. Ignition [40° BTC to TC]

3. Electric Supercharging [BC to 80° ABC] at Intake.

Typical engine dimensions

Bore=3.5″; Stroke=3.0″; Fuel injector diam.=0.5″

Valves=1.0″[actual size]+0.5″[margin−mostly on the outside of the two valves]

Squish Lands≈0.060″ displacement to the piston at TC.

Intake valve≈0.060″ displacement to the piston at TC.

Assuming a Michael May type of combustion chamber, with the exhaust valve clearance of 0.5″ to the piston at TC, as shown in the detailed calculations below.

Below are the specifications of a two cylinder, 2-Stroke ICS engine, i.e. a one Liter, 2-Stroke ICS, 2-cylinder engine, operating with a Perfect Miller Cycle, and some of the detailed calculations, which led to its design.

Displacement: 1 liter, 2-cylinder engine, Intake=1″+0.5″; Exhaust=1″+0.5″.

ER0=CR=18:1

Engine Efficiency>0.55, assumption.

Area (A)=9.62 square inches (area of piston≈area of cylinder).

ho=S/(CR−1) assume ER=CR; ho=3/(18−1)=3/17

CR=(Vd+Vtc)/Vtc

where Vd is the displacement volume at BC (Vcylinder), and Vtc is volume at TC.

Vcylinder=9.62*3.0=28.9 cubic inches

CR0=18=Vd/Vtc+1, Vd/Vtc=17

Vtc=Vd/17=28.9/17=1.70 ci

CR0[at 90°] is the CR0 at ½ the displacement, i.e. ½*STROKE*Area

CR0[90°]=[9.62*(3.0/2)+1.7]/1.7=8.5+1=9.5

Volume[at 75° ABC]=Volume[105° BTC]≈A*[90°+15°/90°]≈9.62*[1.5+0.16]

CR0[75° ABC]=[9.62*1.66+1.7]/1.7=9.4+1=10.4, is the effective compression ratio for this Miller Cycle engine.

Assume, we have the May Fireball Engine, except that it applies to a two-stroke, instead of a four-stroke engine.

The entire combustion volume is under the exhaust valve [1.5″ area], i.e. area Asq0.

The intake valve is at the level of the squish zone at TC, i.e. zero clearance.

Asq0/A=(1.5)²/9.62=2.25/9.62=0.234, a fraction.

A1cup=0.234*9.62=2.25 sq. inches, is the entire area at TC of the May type chamber.

A1cup is the area under the exhaust valve, which equals the entire exposed area at TC.

Vtc=1.7=V1=A1cup*h1

h1=1.7/A1cup=1.7/2.25=0.755 inches, is the height of the exhaust valve at TC.

The squish lands were assumed to be flush with the base of the cylinder head. It is now assumed that the cylinder head has a clearance “dsc” of 0.06″ with the piston, and the squish-lands have the same clearance with the piston, i.e. 0.06″, then for the same CR have to add the clearance volume V3, and reduce he main volume V21 by the same amount.

V3=0.06*A=0.06*9.62=0.577

V21=Vtc−V3=1.7−0.577=1.123

h11=h1*V21/Vtc=0.755*1.123/1.7=0.5 inches, is the minimum clearance to the exhaust valve at TC.

This is a preferred embodiment of the crank/cam timing and the dimensions of a typical 2-Stroke ICS engine, and other preferred embodiments, shown in FIG. 3.

FIG. 3 is a circle drawing showing the preferred embodiments of various timing events of the 2-Stroke ICS engine where the circle represents 360° and completes the operating cycle of the 2-Stroke ICS engine, showing the expansion period, the blow-down period, the scavenging period, the typical fuel injection period, the compression period (and mixing period), and the ignition period. Note that, in general, the two valves open approximately the same time and close approximately simultaneously, or the intake may be slightly delayed in its opening, to give the exhaust time for blow-down.

FIG. 4 is a top view of a two-cylinder engine of a 2-Stroke ICS type engine with two identical cylinders each having two valves 46 and 47, two plugs 41 and 42, a central fuel-injector 45, two squish lands on the two sides of the valves 48 and 49, and has two intakes, a warm intake 63 and cold intake 62 for power, and has a SOHC [single overhead cam] 65, and two exhausts 60. The design is new and has two overhead valves, an intake and exhaust valve and does not require ports in the engine block, has an oil sump, like a normal 4-stroke engine.

This is an advantage, and can use almost any engine block. The intake is always above one atmosphere, which forces oil in the head not to leak into the combustion chamber at light loads (a problem encountered with the experimental, 4-stroke, single-cylinder engine). The engine uses two halo-disc plugs, and a state-of-the-art electronic fuel injector as was used in the Ford PROCO. It uses a Perfect Miller Cycle with a high ER, e.g. of approximately 18:1 for an effective CR of 10.5:1, and preferably a small Electric Super-charger on the intake (and perhaps supplemented with a turbo). And it would be simple to build and maintain.

Since it is truly a two stroke engine, it would have twice the power of a four-stroke engine, all other things being equal. It can have two cylinders, like the Fiat 500, but would be much more efficient and powerful. By incorporating Michael May's combustion chamber in the 2-Stroke ICS design, it would have a low cost, simple design Lean Burn engine with a high efficiency and power. Like numerals refer to like parts with respect to the previous figures.

Note that power can be controlled by a Speed/Density map as in a conventional engine, where Density is proportional to the manifold absolute pressure MAP (˜fuel injection Time), except that in this case it is proportional to the degree of Stratification, which is also proportional to the Volume of injected fuel, i.e. to the fuel injection Time (and to a lesser degree to the mixture equivalence ratio). That is, during the scavenging period, the intake pressure is approximately 1 atmosphere, and the way to vary power during the light load case is to vary the level of injected fuel so that, to first order, different volumes of combustible mixture are made available in the center-most part of the combustion chamber.

Note that FIG. 4 has two intakes, a warm intake 63 and a cold, power intake 62 which has been discussed in my previous patent applications '982 and '148. The warm intake 63 has two subsystem intakes and exhaust manifolds 60 to preheat the intake air, as shown in the FIG. 4, and discussed in my previous patent applications '982 and '148. A method of preheating the intake air is to closely couple the intake manifold with the exhaust manifold, e.g. to place them concentric with each other, and to use high thermal conductive material on the manifolds. In the figure, are shown two warm intakes lying along the two exhausts of the two cylinder engine of FIG. 4.

Note also that the camshaft 65 may act directly on the valve stems with buckets on them used to actuate them, so that a phase change may occur relative to the crank. This would minimize the complexity and cost of the cam/crank system and give the system greater flexibility.

Note that a phase change between the cam and crank may be made to make the intake vary relatively in time duration needed when the engine runs at high speeds. For example, for speeds to 2,000 RPM the intake closing may be 65° ABC, and at 3,000 to 4,000 RPM the intake closing may be at 85° ABC, and the intake opening may be retarded by an equivalent 20°. The electric or mechanical supercharger, or the turbo-charger, may have a higher output at higher speeds, especially at WOT.

At low loads, ultra lean conditions, the fuel injector is designed to give a fuel spray pattern located towards the center of the combustion chamber, away from the cylinder walls, so that in effect there is an air cushion at the walls, to minimize heat transfer to the engine.

When operating near full load or at WOT, it may be preferred to have scavenging with greater amounts of residual burnt gas fraction at valve closure, to limit the level of NOx because of greater amounts of residual burnt gas fraction, or in effect greater EGR.

It is important to insure that the exhaust valve is adequately cooled at high loads to allow a high CR, e.g. approximately 10 to 1 or greater, without knocking.

When operating at cold start, the warm intake 63 will be used, and it will be preferred to have near stoichiometric AFR, and maximum ignition energy, and the ignition timing will be slightly retarded.

The intake valve has a shroud on the inside, more central region, to help the intake air to enter the cylinder-vertically downwards while the exhaust moves vertically upwards, creating an approximately 180° loop. The exhaust valve does not require shrouding since the inner edge of the valve is close to the wall of the exhaust opening.

The air-fuel mixture near top-center (TC) has considerable turbulence due to colliding flows from three sources of squish which help the air and fuel to thoroughly mix in the shorter available time.

While the valves may close very late, e.g. around 75° after-bottom-center (ABC), the CR will not be too low (late closing) or too high (high ER). With good scavenging, the intake air will be at 1 atmosphere when the valves close (by use of a supercharger, during scavenging, on the intake), and the temperature will be at room temperature. That is, by displacing the exhaust gases with fresh intake air, the process takes place at constant temperature and pressure, at NTP, to give a full charge to the cylinder, despite the late valve closing. It is noteworthy that use of scavenging in the two-stroke allows the Miller Cycle to work perfectly.

Since certain changes may be made in the above apparatus and method, without departing from the scope of the invention herein disclosed, it is intended that all matter contained in the above description, or shown in the accompanying drawings, shall be interpreted in an illustrative and not limiting sense.

What is claimed is:

1. A two-stroke ICS engine system with two plugs located in the cylinder head which are placed across from each other, with small, high energy density optimized coils mounted on the plugs, and approximately located at the center of the head is fuel-injector means, and two approximately vertically oriented valves spaced about the center of the head, and two squish-flow lands are on the top and bottom halves of the cylinder, so that when the piston is near or at top center (TC) a channel is formed between the squish lands, the squish clearance between the top of squish land and the piston is less than 0.15 inch at TC, and the clearance between the cylinder head and the piston in the region of the channel is approximately between 0.4 inch and 0.8 inch, for an effective compression ratio (CR) of approximately 10.5 to 1, with the squish flow at the two plug sites is towards the center of the combustion chamber.

2. The system of claim 1 wherein the expansion ratio (ER) of the engine is greater than 14 to 1 and the clearance between the cylinder head and the piston in the region of the channel is approximately 0.4 inch.

3. The system of claim 1 wherein the ER is approximately 18 to 1, and wherein a Miller Cycle is formed with an effective CR of approximately 10.5 and wherein an electric super-charger is on the intake valve.

4. The system of claim 1 wherein the ER is approximately 18 to 1, and wherein a Miller Cycle is formed, and wherein the intake and exhaust valves close at approximately 75° after bottom center (ABC).

5. The system of claim 1 wherein the spark plugs are of the halo-disk type with high energy density optimized coils mounted on the plugs.

6. The system of claim 1 wherein the intake valve is shrouded on its inside edge to insure that the intake air flow moves on the outer edge and essentially vertically down, and the exhaust flow moves more freely on its outside edge, defining a 180° flow orientation.

7. The system of claim 1 wherein the fuel-injector is electronic operated.

8. The system of claim 1 wherein the fuel-injector means can be made to operate also at the time of ignition, say about 30° BTC, to inject a small amount of fuel to help the spark ignition process, especially when an ultra lean mixture is used.

9. The system of claim 1 wherein the combustion chamber is of the Michael May type.

10. The system of claim 9 wherein the intake valve at TC creates strong squish and the combustion chamber is mostly under the exhaust valve.

11. The system of claim 4 wherein the height of the cup-like volume under the exhaust valve is approximately 0.5 inches at top center (TC), and the clearance of the remainder of the cylinder is about 0.06 inches, including the intake valve.

12. An internal combustion (IC) engine system of the two-stroke type, having an Inverted Cross-Scavenged (ICS) type of engine, using two-valves in the head, an intake and exhaust valve, and at least one in-cylinder fuel injector, and wherein the effective compression ratio (CR) is approximately 10.5 to 1, and the expansion ratio (ER) is a high ER approximately 18 to 1, wherein the intake air may need to be slightly pressurized by a quick response electrical operated Supercharger, and wherein said two valves, intake and exhaust, open at approximately 15° to approximately 45° before bottom center (BBC) and close approximately 80° after bottom center (ABC) and wherein the intake air moves downwards at the outer edge of the intake valve and exhaust moves upwards at the outer edge of the exhaust valve, defining a 180° scavenging loop, and fuel is injected immediately after or just as the valves close, and the mixture at the time of ignition may be stratified or homogeneous.

13. The system of claim 12 wherein the quick response electrical operated Supercharger is replaced with a quick response turbo-charger.

14. The system of claim 12 wherein the two valves are off-set with respect to the intake and exhaust openings so as to permit easier air-flow and exhaust-flow on the outer edges of the valves, to help form a 180° flow loop.

15. The system of claim 12 wherein the fuel injector sprays the fuel more towards the center of the combustion chamber and less towards the cylinder walls, especially at light loads or under lean conditions, so that there is, in effect, an air cushion at the cylinder walls, so that there is less heat transfer to the cylinder walls.

16. The system of claim 12 wherein the combustion chamber is of May type which has a small clearance to the piston at TC under the intake valve and a large clearance of about 0.5 inches to the exhaust valve which makes a large part of the “roof” of the combustion chamber where the intake valve is horizontal and has a cup-like volume much smaller than the cup-like volume under the exhaust valve which is also horizontal, the clearance of the intake valve at TC creates inwards radial squish-flow, and for ignition two plugs are used with vertical orientation and are located at the edge of the two squish zones closer to the exhaust valve, so that the manufacture of the head is particularly simple and has four vertical holes drilled per cylinder (two for the valves and two for the plugs), and wherein the valves are in a longitudinal direction to the camshaft, so that a single overhead cam [SOHC] may be employed.

17. A two-stroke internal combustion engine which has an Inverted Cross-Scavenged operation and a central fuel-injector means, having two overhead valves in the cylinder head and optimized coils for the one or more spark plugs, the optimized coils being small, high energy coils and the plugs being halo-disc type plugs, and the combustion chamber forming a Miller Cycle with an effective CR of approximately 10.5 to 1 and ER equal to approximately 18 to 1, and the valves opening at near bottom center (BC) and closing at approximately 75° after BC.

18. The system of claim 17 wherein the ER is equal to 18 to 1, and wherein a Miller Cycle is formed with an effective CR of 10.5 and wherein a super-charger is on the intake valve, and wherein the air-fuel mixture near top-center (TC) has considerable turbulence due to colliding flows from three sources of squish which help the air and fuel to thoroughly mix in the shorter available time.

19. The system of claim 18 wherein the super-charger may be from the collection made up of a mechanical or electric quick response super-chargers and turbo-chargers, and wherein the intake air will be at a pressure of at least approximately 1 atmosphere and the gas temperature will be approximately ambient temperature, and that is by displacing the exhaust gases with fresh intake air the process takes place at constant temperature and pressure, at NTP, to give a full charge to the cylinder, despite the late valve closing, wherein the use of scavenging of the air and exhaust allows the Miller Cycle to work Perfectly.

20. The system of claim 17 wherein said fuel-injector sprays its fuel when the two valves close or are about to close, and the bulk of the fuel spray is towards the center of the cylinder with some fuel reaching the one or more tips of the spark plugs.
